(19) United States
(12) Patent Application Publication
(10) Pub. No.: US 2024/0286967 A1
(43) Pub. Date: Aug. 29, 2024

(54) CARBON-BASED PRODUCTS AND METHODS OF MAKING SAME

(71) Applicant: Sulvaris Inc., Calgary (CA)

(72) Inventors: Mitchel Flegel, Calgary (CA); Cristine Selirio, Calgary (CA); Prem Pokharel, Calgary (CA); Mark Howell, Calgary (CA); Robert Mackie, Calgary (CA)

(21) Appl. No.: 18/590,662

(22) Filed: Feb. 28, 2024

Related U.S. Application Data
(60) Provisional application No. 63/487,506, filed on Feb. 28, 2023.

(51) Int. Cl. C05C 3/00; C05C 9/00; C05G 3/40; C05G 5/12; C05G 5/40

(52) U.S. Cl. CPC C05C 3/00; C05C 9/005; C05G 3/40; C05G 5/12; C05G 5/40

(57) ABSTRACT

The present disclosure relates generally to carbon-based products. More particularly, the present disclosure relates to acid-impregnated carbon-based products having at least one nitrogen-containing compound covalently bound to a porous carbon matrix, methods of making same, and uses of same in industry and agriculture.

### CROSS-REFERENCE TO RELATED APPLICATION

This application claims the benefit under 35 U.S.C. § 119(e) of U.S. Provisional Patent Application Ser. No. 63/487,506, filed Feb. 28, 2023, the disclosure of which is hereby incorporated herein in its entirety by this reference.

### TECHNICAL FIELD

The present disclosure relates generally to carbon-based products. More particularly, the present disclosure relates to acid-impregnated carbon-based products having at least one nitrogen-containing compound covalently bound to a porous carbon matrix, methods of making same, and uses of same in industry and agriculture.

### BACKGROUND

Agriculture today is defined by the need for massive increases in crop yields through accelerating modernization to support the increase in the global human population, while simultaneously minimizing negative environmental impacts. However, soil nutrients are often not being efficiently replaced to maintain high crop yields in a sustainable manner or are being lost to leaching and volatilization resulting in reduced economics for farmers due to the need for reapplication and over-application of fertilizers. Many common fertilizers that exist today are applied in highly water-soluble forms which render them susceptible to leaching and/or volatilization, which comes at an economic and environmental cost. The global problem of fertilizer runoff is growing and exacerbated by population growth, urbanization and the resultant constant need for higher and higher crop yields.

Inefficient use of nitrogen (N) fertilizer has been a major concern in agriculture. Nitrogen use efficiency, defined as the percentage of applied N used by the crop, for cereal crops varies between 21-41% with a global average of 35% (Omara et al., 2019) and is based on the type of fertilizer used, application method, time, rate of application, and environment. Major N loss pathways are leaching of nitrate and gaseous loss via ammonia volatilization. Loss of N through ammonia volatilization increases with soil pH, temperature, and application method. Higher temperature enhances urease activity and surface application facilitates the diffusion of ammonia into the atmosphere. The loss can be greater than 15% regardless of soil and environmental conditions. In warmer climates, loss of N from urea application reaches up to 78% (global demand in 2020 was 118.7 million tonnes of urea fertilizer, while nitrogen use efficiency was only 38%). In certain cases, farmers will still use surface application of urea resulting in higher loss of nitrogen to ammonia volatilization. Furthermore, enhanced efficiency fertilizers have been identified as a critical component of 4R nutrient stewardship to help mitigate nitrogen losses from synthetic fertilizers. Such fertilizers have demonstrated reductions in ammonia volatilization, leaching losses which are deleterious to aquatic environments, and potent greenhouse gases in the form of nitrous oxide emissions, all while maintaining or improving crop yields. 4R nutrient stewardship has been recommended for fertilizer use at right rate, right time, right source, and right place to minimize loss and increase nutrient use efficiency that will eventually be useful in increasing crop production and farmer's profit. However, it is not always possible to follow 4R principles for every farmer due to management and logistic issues, or limitations of equipment or access to fertilizer technologies. So, it is essential to identify the best management practice to address the farmers' interests, which is always challenging as certain practices do not work best everywhere in every situation. Thus, innovating new technologies that can fill those gaps has immense opportunity to help address the farmers' interests in increasing their crop yield and return on investment, while fitting in with common and economical application methods.

Carbon-based fertilizers, also known as organo-mineral fertilizers, have shown multiple benefits in the agricultural industry, such as boosting soil fertility and quality (Hertsgaard, 2014). Carbon-based fertilizers can also mitigate the negative impacts of heavy metals and other pollutants in soil (Hertsgaard, 2014). Carbon-based fertilizers are highly porous in structure and can have large surface areas. In the soil, these attributes allow for the adsorption and potential slow-release of nutrients, adsorption of dissolved organic compounds, as well as providing a space for microorganisms and fungi to reside. This can contribute to significant improvements in overall soil health through increased soil fertility, better soil structure, and improved soil chemistry and biology. Additionally, if the carbon-based fertilizer is processed in a certain way which creates properties that resist decomposition, the source materials can be diverted from a greenhouse gas (GHG) source to a potential sink when placed in soil due to slow degradation of the carbon material (Spear, 2018).

However, carbon-based fertilizers are not mainstream due to the high temperatures needed to produce them, low nutrient content, low density, handling difficulties, low yield and there is a need in the art for carbon-based products that are produced at lower temperatures with increased nutrient contents and improved fertilizer properties, such as higher retention and slow-release of nitrogen-containing compounds.

### BRIEF SUMMARY

In a first aspect of the present disclosure, a method of producing a porous carbon matrix product from a carbonaceous biomass material is provided. The method comprises:
(a) treating the carbonaceous biomass material with at least one nitrogen-containing compound;
(b) applying a mineral acid to the carbonaceous biomass material while mixing both components for a period of time, thereby leaving the mineral acid impregnated in the carbonaceous biomass material and covalently binding the nitrogen-containing compound to the carbonaceous biomass material; and
(c) converting the mineral acid to its corresponding salt by exposing the acid-impregnated carbonaceous biomass material to ammonia,
wherein the porous carbon matrix product contains nitrogen bound to the porous carbon matrix.

In an embodiment of the method provided herein, step (b) is performed before step (a).

In an embodiment of the method provided herein, the covalently bound nitrogen is from the nitrogen-containing compound and/or the salt.

In an embodiment of the method provided herein, the carbonaceous biomass material comprises wood, digested, composted, or raw animal manure, lignocellulosic materials, agriculture wastes, agricultural by-products, organic residues, organic by-products, peat moss, bagasse, oil palm refuse, oil palm by-products, straw, municipal solid waste, bedding materials containing manure, food wastes and by-products, nut shells or coconut coir.

In an embodiment of the method provided herein, the carbonaceous biomass material comprises wood, and the wood comprises wood shavings, wood pulp or wood powder.

In an embodiment of the method provided herein, the carbonaceous biomass material comprises wood, and the wood is pine wood.

In an embodiment of the method provided herein, the at least one nitrogen-containing compound is present in an aqueous solution.

In an embodiment of the method provided herein, the at least one nitrogen-containing compound has an active or available carbonyl or imine group.

In an embodiment of the method provided herein, the at least one nitrogen-containing compound comprises an active or available carbonyl or imine group.

In an embodiment of the method provided herein, the at least one nitrogen-containing compound comprises urea.

In an embodiment of the method provided herein, the at least one nitrogen-containing compound comprises urea at an amount to achieve a specified nutrient profile.

In an embodiment of the method provided herein, step (b) further comprises applying heat in addition to applying the mineral acid.

In an embodiment of the method provided herein, the temperature of step (b) does not exceed 400 degrees Celsius, preferably does not exceed 350 degrees Celsius, more preferably does not exceed 300 degrees Celsius, more preferably does not exceed 250 degrees Celsius, more preferably does not exceed 200 degrees Celsius, more preferably does not exceed 150 degrees Celsius, and more preferably does not exceed 100 degrees Celsius.

In an embodiment of the method provided herein, the mineral acid is sulfuric acid, nitric acid, phosphoric acid, polyphosphoric acid, hydrochloric acid, and/or a combination thereof.

In an embodiment of the method provided herein, the mineral acid is sulfuric acid.

In an embodiment of the method provided herein, the ammonia is ammonia gas or aqueous ammonia.

In an embodiment of the method provided herein, step (c) comprises flowing an ammonia gas or aqueous ammonia over or through the acid-impregnated carbonaceous biomass material.

In an embodiment of the method provided herein, the salt is ammonium sulfate, ammonium nitrate, ammonium phosphate or ammonium chloride.

In an embodiment of the method provided herein, the salt is ammonium sulfate.

In an embodiment of the method provided herein, the method further comprises, prior to the performance of steps (a), (b) and (c), grinding the carbonaceous biomass material to a suitable particle size range.

In an embodiment of the method provided herein, the method further comprises, after step (c), screening, pelletizing or granulating the porous carbon matrix product to a suitable particle size range.

In a second aspect of the present disclosure, a porous carbon matrix product is provided. The porous carbon matrix product is produced by the method according to the first aspect.

In an embodiment of the porous carbon matrix product provided herein, ammonia volatilization is reduced, compared to product produced without treating the carbonaceous biomass material with at least one nitrogen-containing compound.

In an embodiment of the porous carbon matrix product provided herein, the slow-released nitrogen is inorganic nitrogen.

In an embodiment of the porous carbon matrix product provided herein, the slow-released nitrogen is organic nitrogen.

In a third aspect of the present disclosure, a slow-release fertilizer product is provided. The slow-release fertilizer product comprises a porous carbon matrix and at least one nitrogen-containing compound covalently bound to the porous carbon matrix, wherein the porous carbon matrix is impregnated with a mineral acid salt of ammonia.

In an embodiment of the slow-release fertilizer product provided herein, the at least one nitrogen-containing compound comprises an active or available carbonyl or imine group.

In an embodiment of the slow-release fertilizer product provided herein, the at least one nitrogen-containing compound comprises urea.

In an embodiment of the slow-release fertilizer product provided herein, the mineral acid is sulfuric acid, nitric acid, phosphoric acid, polyphosphoric acid, hydrochloric acid, and/or a combination thereof.

In an embodiment of the slow-release fertilizer product provided herein, the at least one nitrogen-containing compound is released from the fertilizer due to microbial activity over the course of a growing season.

In an embodiment of the slow-release fertilizer product provided herein, ammonia volatilization is reduced, compared to product produced without treating the carbonaceous biomass material with at least one nitrogen-containing compound.

In an embodiment of the slow-release fertilizer product provided herein, the slow-released nitrogen is inorganic nitrogen.

In an embodiment of the slow-release fertilizer product provided herein, the slow-released nitrogen is organic nitrogen.

### BRIEF DESCRIPTION OF THE DRAWINGS

In order that the subject matter of the present disclosure may be readily understood, embodiments are illustrated by way of the accompanying drawings.

FIG. 1 is an image of pinewood shavings, a carbonaceous biomass material used as a starting material for certain embodiments of the invention.

FIG. 2 shows images of carbonaceous biomass material before and after acidulation with sulfuric acid.

FIG. 3 shows images of acidulated carbonaceous biomass material during the process of ammoniation using aqueous ammonia solution.

FIG. 4 is a graph illustrating the cumulative ammonia volatilization loss from urea and porous carbon matrix products treated with urea before acidulation and after acidulation.

FIG. 5 is a graph illustrating the cumulative ammonia volatilization loss from urea and porous carbon matrix products treated with urea before acidulation and temperature added during acidulation.

FIG. 6 is a graph illustrating the cumulative ammonia volatilization loss from urea and porous carbon matrix products treated with urea before acidulation with either added temperature or ambient conditions during acidulation.

FIG. 7 is a graph illustrating the recovered N as a % of total N applied for ammonium sulfate, urea and Environmentally Smart Nitrogen fertilizers, and various porous carbon matrix products treated with urea before acidulation, and various temperatures of the acidulation reaction.

FIG. 8 is a graph illustrating the percent N uptake by corn at different stages of growth (Bender et al., Better crops with plant food, Vol. 97 (2013, No. 1): 7-10).

Other features and advantages of the present disclosure will become more apparent from the following detailed description and from the exemplary embodiments.

### DETAILED DESCRIPTION

### Definitions

The terminology used herein is for the purpose of describing particular embodiments only and is not intended to be limiting of example embodiments of the invention. Unless defined otherwise, all technical and scientific terms used herein generally have the same meaning as commonly understood by those of ordinary skill in the art. Generally, nomenclatures used in connection with the methods described herein are those well-known and commonly used in the art. Nevertheless, definitions of selected terms are provided below for clarity and consistency.

As used herein, the singular forms following “a,” “an,” and “the” are intended to include the plural forms as well, unless the context clearly indicates otherwise.

The phrase “and/or” should be understood to mean “either or both” of the elements so conjoined, i.e., elements that are conjunctively present in some cases and disjunctively present in other cases. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, the phrase “one or more,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “one or more” refers, whether related or unrelated to those elements specifically identified. Thus, as a non-limiting example, “one or more of A and B” (or, equivalently, “one or more of A or B,” or, equivalently “one or more of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the term “about” is used in conjunction with a numerical range, it modifies that range by extending the boundaries above and below those numerical values. In general, the term “about” is used herein to modify a numerical value above and below the stated value by a variance of 20%, 10%, 5%, or 1%. In certain embodiments, the term “about” is used to modify a numerical value above and below the stated value by a variance of 10%. In certain embodiments, the term “about” is used to modify a numerical value above and below the stated value by a variance of 5%. In certain embodiments, the term “about” is used to modify a numerical value above and below the stated value by a variance of 1%.

When a range of values is listed herein, it is intended to encompass each value and sub-range within that range. For example, “1-5 g” is intended to encompass 1 g, 2 g, 3 g, 4 g, 5 g, 1-2 g, 1-3 g, 1-4 g, 1-5 g, 2-3 g, 2-4 g, 2-5 g, 3-4 g, 3-5 g, and 4-5 g.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The term “consisting of” and its derivatives, as used herein, are intended to be closed terms that specify the presence of stated features, integers, steps, operations, elements, and/or components, and exclude the presence or addition of one or more other features, integers, steps, operations, elements and/or components.

“Carbonaceous material” shall mean any biomass material, which includes recently or once living biological material such as plants, animals, algae, or micro-organisms, or any materials or residues formed from once living organisms. Carbonaceous materials may include, without limitation, textile waste, marine waste, wood and other lignocellulosic material, agriculture wastes or by-products, organic residues, organic by-products, animal wastes or byproducts such as digested or composted animal manure, agricultural byproducts such as raw, digested or composted animal manure, peat moss, bagasse, oil palm by-products or refuse, straw, municipal solid waste or compost, bedding materials containing manure, food waste, food production by-products or waste, nut shells, coconut coir, and fossil fuels and fossil fuel byproducts such as coal and petroleum coke. The terms “carbonaceous material”, “carbonaceous biomass material” and “biomass” are used interchangeably herein.

“Mineral acid” shall mean any inorganic acid including, but not limited to, sulfuric, phosphoric, polyphosphoric, nitric, or hydrochloric acid, and/or combinations thereof.

The terms “porous carbon” and “porous carbon matrix” are used interchangeably and shall mean a solid microporous material produced at a temperature less than pyrolysis temperatures, with high surface area in a solid form, consisting of stable and labile forms of carbon, sufficiently porous to allow passage of gas into its interior spaces. Comprised primarily of carbon, oxygen and hydrogen and containing small amounts of other elements originally found in the carbonaceous materials from which the porous carbon was formed, which may include but are not limited to such elements as nitrogen, sulfur, phosphorus, silicon, aluminum, iron, calcium, magnesium, sodium, and potassium.

“Gas” shall mean any substance or combination of substances that exists in a gaseous state at standard temperature and pressure.

“Chemisorption” shall mean the attachment or adsorption of a gas molecule onto a solid or liquid surface and any reactions that might ensue between the gas molecule and the solid or liquid.

“Acidulation,” as used herein, refers to a process in which a carbonaceous biomass sample is impregnated with acid, such as, but not limited to sulfuric acid (SA), phosphoric acid (PA), nitric acid (NA), hydrochloric acid (HCl), or polyphosphoric acid (PPA).

“Ammoniation,” as used herein, refers to a process in which a sample is treated with ammonia (NH₃) gas or liquid ammonia (e.g., aqueous ammonia solution) to neutralize residual acid or react with surface moieties on the surface of the carbon matrix.

“Carbonization,” as used herein, refers to a process of dehydration of a sample, resulting in a porous carbon matrix.

“Slow-release fertilizer” as used herein, refers to release of the desired nutrient in a fertilizer such as, but not limited to nitrogen, sulfur, or potassium, at a desired release rate into the soil, which minimizes loss of the nutrient to the surrounding environment that renders it unavailable for plant uptake. Criteria for the release rate may depend on the nutrient type. For example, with nitrogen, the criteria for a slow-release fertilizer may require that there be at a minimum 15% N in a slowly available form when compared to a soluble reference product (AAPFCO, 2011). Further criteria may require there to be no more than 15% nutrient released in 24 hours; no more than 75% released in 28 days; and at least about 75% released at the stated release time.

“Enhanced Efficiency” as used herein, refers to fertilizer products with characteristics that allow increased plant nutrient availability and reduce the potential of nutrient losses to the environment when compared to an appropriate reference product (AAPFCO, 2009).

The terms “nitrogen treatment,” “nitrogen pre-treatment” and “pre-treatment” are used interchangeably herein to refer to the addition of a nitrogen-containing compound to a carbonaceous biomass material, either before or after acidulation with a mineral acid.

The terms “CCT Nitro” and “N-Treated CCT” and “CCT” are used interchangeably herein to refer to the final carbon product having the carbonaceous material treated with a nitrogen-containing compound either before or after acidulation with a mineral acid, treated with a mineral acid, followed by treatment with an ammonia source to neutralize any remaining residual acid.

### General Methods:

The inventors have previously found that carbonaceous materials will react with liquid acid to form a porous carbon matrix impregnated with the acid. This reaction may occur under ambient conditions, as described in U.S. Pat. No. 8,198,211, which is herein incorporated by reference.

In general terms, an acid-impregnated porous carbon matrix may be formed by:
1. If necessary, adjusting the moisture content of a carbonaceous material to the desired level;
2. Adjusting the particle size of the carbonaceous material to the desired range;
3. Applying liquid acid to the carbonaceous material; and
4. Mixing the carbonaceous material and liquid acid until the chemical reaction is complete.

The carbonaceous material may comprise any suitable biomass material, including wood and other lignocellulosic material, agriculture wastes, agricultural by-products, organic residues, organic by-products, animal waste or byproducts such as raw, digested or composted animal manure, peat moss, bagasse, oil palm refuse, oil palm by-products, straw, municipal solid waste, bedding materials containing manure, nut shells, coconut coir, coal and petroleum coke. Wood chips or shavings are a particularly preferred carbonaceous material.

The moisture content of the carbonaceous material depends on the feedstock and the particle size and may have a range of about zero to 50% on a wet mass basis, preferably about 5 to 35%. The carbonaceous material may be dried if the moisture content is higher than the desired level, or water may be added to the carbonaceous material to increase the moisture content to the desired level.

The carbonaceous material may be processed into particles of an appropriate size, depending on the intended application and the feedstock, by any suitable method, including for example, chopping, grinding, cutting or otherwise reducing the particle size. Additionally, if the feedstock consists of very small particles, the particles may be agglomerated to create larger particles of a suitable size. The particle size of the carbonaceous material may have an average range of about 0.1 mm to 10 mm, preferably about 0.1 to 5 mm and more preferably about 0.1 to 1 mm.

The liquid acid used for acidulation may be any suitable mineral acid, such as sulfuric, phosphoric, polyphosphoric, hydrochloric, or nitric acid and/or combinations thereof. The choice of acid will change the salt formed if the acid reacts with a chemisorbed molecule. Thus, if ammonia is being used, then the use of sulfuric acid will result in the formation of ammonium sulfate.

The concentration of liquid acid used depends on the moisture content of the carbonaceous material and the desired nutrient content of the final carbon-based product. Suitable acid concentrations may have a range of about 20 to 100%, preferably about 75 to 100% and more preferably 100% (where 100% is the concentrated form of the acid). The amount of liquid acid used depends in part on the desired nutrient analysis and may have a ratio range of about 0.20:1 acid:biomass to 2.5:1 acid:biomass (by weight).

The carbonaceous material and the liquid acid are mixed until the reaction is substantially complete. The length of time depends on the moisture content, particle size, acid concentration and feedstock:acid ratio, but is typically between about 2 to 35 minutes, preferably about 5 to 25 minutes and more preferably about 15 minutes.

In one embodiment, completion of the reaction may be monitored by temperature. As the reaction starts, the temperature typically rises to reach a maximum and falls as the reaction completes.

In one embodiment, the liquid acid is sprayed on the carbonaceous material as mixing proceeds. In another embodiment, the carbonaceous material is formed into pellets and then the liquid acid is applied to the pelletized form of carbonaceous material.

In one embodiment, the conversion of the carbonaceous material to porous carbon matrix, and the impregnation of acid, takes place in one step. Furthermore, the acid-impregnated porous carbon matrix does not require further processing prior to use as a chemisorbent.

In one embodiment, the porous carbon matrix may be used to remove ammonia from a gas stream. Ammonia reacts with inorganic acids to form the corresponding ammonium salt and will be retained by the solid porous carbon matrix as the gas or liquid passes through.

A gas or liquid stream containing ammonia may be routed through a reaction vessel comprising the acid-impregnated porous carbon matrix, either in solid, granular or pelletized form. The porous carbon matrix may comprise a fixed bed or may be disturbed by gas flow or by mechanical means, such as with a fluidized bed, drum granulator or a pseudo fluidized bed. Preferably, means are provided to periodically replenish or replace the porous carbon matrix.

The ammonia is chemisorbed by the acid-impregnated porous carbon matrix and converted to a fertilizer salt with little residual acidity, and containing carbon, oxygen, hydrogen and other elements. Thus, the spent porous carbon matrix is a useful source of selected nutrients for agriculture and horticultural applications. As such, the expense of ammonia removal is reduced and a value-added by-product is created.

The porous carbon matrix product may be pelletized or granulated using conventional methods to form fertilizer pellets or otherwise processed into a useful agricultural or horticultural form.

The inventors have found that treatment of the carbonaceous material with at least one nitrogen containing compound either prior to application of liquid acid to the carbonaceous material or after application of liquid acid to the carbonaceous material may produce carbon-based fertilizers with higher nitrogen content. Suitable nitrogen containing compounds contain an activated carbonyl, for instance in urea (carbamide), or an imine group, for instance in arginine. Further, the inventors found that treatment of the carbonaceous material with at least one nitrogen containing compound prior to the application of liquid acid to the carbonaceous material and added heat under 350° C. during the treatment of liquid acid to the carbonaceous material may produce carbon-based fertilizers with a slow-release mechanism for nitrogen compounds and a decrease in ammonia volatilization potential.

The carbonaceous material can be treated with a nitrogen containing substance either prior to acidulation or after acidulation. The amount of nitrogen used during treatment depends in part on the desired nutrient retention and nutrient analysis. Suitable nitrogen treatment concentrations may have a range of about 2:1 treatment:biomass to about 1:5 treatment:biomass (by dry weight). Nitrogen treatments are typically dissolved with minimal water and added to the carbonaceous material and allowed to soak into the biomass material. Suitable acid concentrations may have a range from about 0.20:1 acid:biomass to about 2:1 acid:biomass (by weight). Suitable temperature treatments may be less than pyrolysis temperatures and may include temperatures of under 400° C., preferably under 350° C., more preferably under 300° C., more preferably under 250° C., more preferably under 200° C., more preferably under 150° C., and more preferably under 100° C. Suitable temperature treatments may have a range of 100° C. to 350° C. during acidulation and more preferably less than about 200° C. The desired slow-release or reduction of ammonia volatilization potential depends in part on the amount of liquid acid used during treatment of the carbonaceous material and the temperature applied during the acidulation of the carbonaceous material. With high acid ratios and high temperature, the carbonaceous material will degrade at a high rate versus a high acid ratio and lower temperature or a low acid ratio and lower temperature.

### EXAMPLES

The disclosure is further described by reference to the following examples. These examples are provided for purposes of illustration only and are not intended to be limiting unless otherwise specified. Thus, the disclosure should in no way be construed as being limited to the following examples, but rather, should be construed to encompass any and all variations which become evident as a result of the teaching provided herein.

### Example 1: Development of Carbonaceous Biomass Material Pre-Treatment Methods

Various methods for pre-treating a carbonaceous biomass sample (e.g., wood shavings) were examined to investigate the potential retention of nitrogen on the carbon matrix and the nitrogen slow-release qualities of the carbon samples.

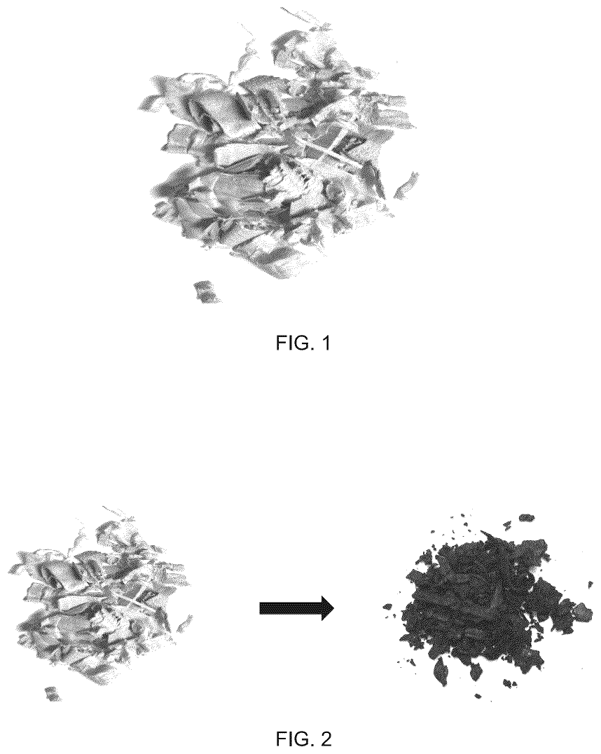

A carbonaceous biomass material consisting of pinewood shavings (FIG. 1) was pre-treated with different nitrogen and phosphate sources to determine if such modifications to the biomass affect nutrient retention in the resulting porous carbon matrix product. Combustion analysis was used to measure the percentages of total sulfur (TS), total carbon (TC) and total nitrogen (TN) in the pre-treated and acidulated sample, ammoniated sample, and washed ammoniated sample to determine if there was any nutrient retention in the resulting porous carbon matrix product. A further Ion Chromatography method was used to measure the percentage of N washed from the product.

### Materials and Methods:

The following general process was used to make the porous carbon matrix with retained nitrogen product:
1. Pre-treatment: A N-source contained in an aqueous solution or a gas (i.e., ammonia gas) was added to the carbonaceous material at a certain ratio of N-source to biomass on a dry weight basis. The N-source solution was allowed to soak with the biomass for a certain period of time, followed by optional drying of the biomass overnight at 70° C. prior to the acidulation step.
2. Acidulation: A mineral acid (i.e., sulfuric acid) was slowly added to the pre-treated carbonaceous material (i.e., pinewood shavings) at 1:1 acid to pre-treated biomass ratio on a dry weight basis. The resulting acidulated porous carbon matrix sample was slowly stirred with a glass rod by hand for 5 minutes or until all the carbonaceous biomass was coated/reacted. The highest temperature of the acidulation reaction was recorded. Samples were then partitioned to be analyzed by combustion analysis. Samples were dried at 70° C. overnight prior to combustion analysis.
3. Ammoniation: The pre-treated and acidulated porous carbon matrix samples were placed in an atmosphere of ammonia within a sealed vacuum chamber. The lid was properly greased, and a tight seal was ensured prior to use of the vacuum chamber. The samples were evenly distributed in the chamber and then aerated with gaseous ammonia in the sealed chamber for 2 hours. To ensure even ammoniation treatment, samples were periodically mixed in the vacuum chamber and the process was repeated if necessary. Once ammoniation was completed by testing full neutralization, the samples were vacuum filtrated before being dried in the oven at 70° C. or until the moisture content was less than 5%. Samples were weighed and then partitioned to be analyzed via combustion analysis.
4. Alternate Ammoniation Procedure: The pre-treated and acidulated porous carbon matrix samples were slowly added to aqueous ammonia solution and stirred with a glass rod by hand for 5 minutes or until all the pinewood shavings were coated/reacted to neutralize the residual acid. The highest temperature of the ammoniation reaction was recorded. Samples were then partitioned to be analyzed by combustion analysis. Samples were dried at 70° C. overnight prior to combustion analysis.
5. Washing Procedure: The pre-treated, acidulated and ammoniated porous carbon matrix (CCT) samples were extracted using deionized water, unless otherwise indicated. Samples were shaken for 1 hour before decanting. The process was monitored by pH and electrical conductivity (EC) to ensure samples were thoroughly washed to remove any soluble salts or residual acid. Samples were then vacuum filtered using a filter paper, dried in the oven at 70° C. and weighed before combustion analysis to measure the retained nutrients.
6. Alternate Washing Procedure: The pre-treated, acidulated and ammoniated porous carbon matrix (CCT) samples were extracted with deionized (DI) water using the Extraction of Available N from Soil Sample Standard Operating Procedure (SOP) (Maynard and Karla, 1993), as set out below.

In a 50 mL centrifuge tube, 5 g of sample was weighed and added 25 mL of DI water. The tubes were shaken on a soil shaker for 1 hour to ensure good extraction. After shaking, the tubes were centrifuged at 4000 rpm for 5 minutes to allow solids to settle. Samples were then decanted, filtered through 0.45 μm filter and the collected filtrates were analyzed using Ion Chromatography (IC) for ammonium, nitrate, and nitrite as well as soluble organic-N (i.e., urea) using combustion analysis or where indicated, the persulfate method (Borba et al., 2016) followed by IC analysis. The nitrogen content in the filtrate was then calculated to determine the amount of nitrogen removed from the CCT sample. The amount retained and not removed from the washing was calculated as a % of C bound N.

### Results:

In an initial analysis, three types of carbonaceous biomass materials-fine wood sawdust, pinewood shaving, and soluble seaweed extracts-were used to produce porous carbon matrix products without any nitrogen pre-treatment. Combustion analysis of TC, TN, and TS revealed that the three types of biomasses were comparable, as shown in Table 1. In addition, after ammoniation and washing, no nitrogen was retained in the sample.

TABLE 1
Combustion analysis results of various carbonaceous biomass
materials (Fine wood sawdust, Pinewood shaving, and Soluble
Seaweed Extract) after acidulation, ammoniation and washing.

| | Combustion Analysis (%) | | |
|---|---|---|---|
| Biomass | TC | TN | TS |
| Fine wood sawdust | 45 | 0.4 | <0.06 |
| Acidulated fine wood sawdust | 23 | 0.28 | 14* |
| Acidulated and ammoniated fine | 46 | 0.4 | 0.81 |
| wood sawdust - washed | | | |
| Pinewood shaving | 44 | 0.4 | <0.06 |
| Acidulated Pinewood shaving | 19 | 0.22 | 15 |
| Acidulated and ammoniated Pinewood | 54 | 0.5 | 0.96 |
| shaving - washed | | | |
| Soluble Seaweed Extract | 26 | 0.6 | 1.2 |
| Acidulated Soluble Seaweed Extract | 24 | 0.49 | 16* |
| Acidulated and ammoniated Soluble | 48 | 1.6 | 0.38 |
| Seaweed Extract - washed | | | |

*indicates that the sample exceeded the calibration range.

The following pre-treatment methods were then evaluated:
No chemical pre-treatment (i.e., the pre-treatment was limited to physical treatments to reach a target moisture content and suitable particle size) (No Pre-Treatment);
Pre-treatment of the biomass with aqueous ammonia (Aq. Ammonia) at a 1:1 ratio of aqueous ammonia:biomass for 30 minutes followed by drying overnight at 70° C. (Aq. Ammonia Pre-Treatment);
Pre-treatment of the biomass with gaseous ammonia in a sealed and pressurized container for 1-2 hours;
Pre-treatment of the biomass with a lysine solution in a 0.6:1 ratio of lysine:biomass followed by drying overnight at 70° C.;
Pre-treatment of the biomass with an arginine solution in a 0.6:1 ratio of arginine:biomass followed by drying overnight at 70° C.; (Arginine Pre-Treatment);
Pre-treatment of the biomass with ammonium polyphosphate (APP) solution at a 2:1 ratio of APP solution:biomass overnight followed by drying overnight at 70° C. (APP Pre-Treatment).

When monitoring the acidulation reaction after pre-treatment of the biomass, the highest reaction temperatures (i.e., highest exotherms) reached are shown in Table 2. The highest reaction temperature reached for arginine and aqueous ammonia pre-treatments was 125° C. and 153° C., respectively, compared to a peak temperature of 85° C. for the APP treatment.

TABLE 2
The reaction temperature of the acidulated porous carbon
matrix and the pH and EC (electrical conductivity)
of the filtrate after washing with DI water.

| | Acidulation | | |
|---|---|---|---|
| | Temperature | Filtrate | |
| Sample | (° C.) | pH | EC (μS/cm) |
| No Pre-Treatment | 150 | 7.19 | 330.5 |
| APP Pre-Treatment | 85 | 7.94 | 5.8 |
| Arginine Pre-Treatment | 125 | 7.27 | 400.1 |
| Aq. Ammonia Pre-Treatment | 153 | 7.36 | 407.4 |

Pre-treated samples of the biomass (i.e., pinewood shavings) were then acidulated, ammoniated, washed, and at each step were analyzed by combustion analysis to determine the effect of the pre-treatment on the acidulation reaction and the final nutrient analysis (Table 3).

Among the pre-treatments analyzed, arginine exhibited the highest N content retention after ammoniation and washing of the ammoniated material (Table 3). This indicates that there was some nutrient chemical binding to the carbon matrix due to some functional moieties. Other pre-treatments such as APP or aqueous ammonia (also referred to as aq. ammonia) showed very little retention of nitrogen on the carbon matrix after ammoniation and washing of the ammoniated material.

TABLE 3
Combustion analysis results of the acidulated,
ammoniated and washed pine wood shavings pre-treated
with APP, arginine, and aqueous ammonia.

| | Combustion Analysis (%) | | |
|---|---|---|---|
| Sample | TC | TN | TS |
| APP Pre-Treatment | 11 | 4.1 | 15 |
| APP Pre-Treatment - Washed | 46 | 1.3 | 1.7 |
| Arginine Pre-Treatment | 18 | 5.5 | 16 |
| Arginine Pre-Treatment - Washed | 45 | 6.2 | 2.9 |
| Aq. Ammonia Pre-Treatment | 21 | 0.34 | 16 |
| Aq. Ammonia Pre-Treatment - Washed | 53 | 0.5 | 0.93 |

In summary, these assays showed that porous carbon matrix products pre-treated with arginine had the highest total nitrogen retention among the tested pre-treatments.

### Example 2: Optimization of Carbonaceous Biomass Pre-Treatment Methods

Experiments were conducted to further investigate if different nitrogen sources at different concentrations affect the nutrient retention of the resulting porous carbon matrix product (CCT).

### Pre-Treatment:

Pre-treatments were prepared in a beaker and then slowly added to a 50 g sample of carbonaceous biomass, i.e., pinewood shavings. A glass rod was used to mix the sample to ensure that all pinewood shavings are uniformly mixed with the pre-treatment solution. Standard soak time at room temperature for all pre-treatments was 3 days unless otherwise specified. Pre-treated samples were then dried overnight at 70° C. prior to acidulation.

Solutions of urea were tested as a pre-treatment for carbonaceous biomass samples. For pre-treatment, 50 g of pinewood shavings were soaked in 0.3:1, 0.6:1, and 1:1 ratios of urea:biomass on a dry weight basis. The soak times for 0.6:1 ratio urea:biomass pre-treatments were: (a) 1 day; (b) 3 days (standard soak time); (c) 1 week; and (d) 4 weeks. The soak times for 1:1 urea:biomass pre-treatments were: (a) 1 day; and (b) 3 days (standard soak time). The pre-treated samples were placed in a vacuum chamber for 5 hours, then dried overnight at 70° C. prior to acidulation.

Solutions of arginine were tested as a pre-treatment for carbonaceous biomass samples at 0.3:1 and 0.6:1 ratio of arginine:biomass on a dry weight basis. For pre-treatment, 50 g of pinewood shavings were soaked in the respective arginine solutions for 1 day, then dried overnight at 70° C. prior to acidulation.

Solutions of lysine were tested as a pre-treatment for carbonaceous biomass samples at 0.3:1, 0.6:1, and 1:1 ratio of lysine:biomass on a dry weight basis. For pre-treatment, 50 g of pinewood shaving were soaked in the respective lysine solution for 1 day, then dried overnight at 70° C. prior to acidulation.

Aqueous ammonia (30 wt % solution of NH₃ in water) was tested as a pre-treatment for carbonaceous biomass samples. For pre-treatment, 50 g of pinewood shavings were soaked in the respective concentration at 1:1 Aq. Ammonia:biomass ratio (by weight). Additionally, biomass samples overloaded with aqueous ammonia were also tested. For the overload pre-treatments, pinewood shavings were treated with aqueous ammonia, dried, and treated again two more times at a 1:1 Aq. Ammonia:biomass ratio (by weight) with drying in between for maximum saturation (i.e., for a total of three consecutive aqueous ammonia pre-treatments).

Polyacrylamide solution was tested as a pre-treatment for carbonaceous biomass samples at a 0.3:1 ratio of polyacrylamide:biomass on a dry weight basis. Due to the gelling nature of the polyacrylamide, only the 0.3:1 ratio as investigated.

### Acidulation:

Sulfuric acid was slowly added to the pre-treated pinewood shavings at 1:1 sulfuric acid to pre-treated biomass ratio. The resulting acidulated porous carbon matrix sample was slowly stirred with a glass rod by hand for 5 minutes or until all the pinewood shavings were coated/reacted. The highest temperature of the acidulation reaction was recorded.

Samples were then partitioned to be analyzed via combustion analysis. Sample were dried at 70° C. prior to combustion analysis.

### Ammoniation:

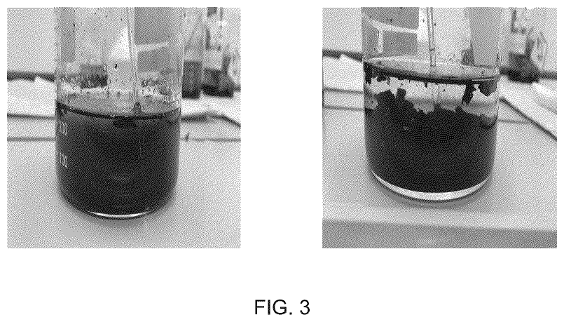

A number of the pretreated, acidulated porous carbon matrix samples were subsampled to be ammoniated with aqueous ammonia at 1:1 Aq. Ammonia solution to acidulated biomass ratio (FIG. 3). To ensure even ammoniation treatment, samples were periodically mixed in the container for a period of three days. The following samples were ammoniated:
Urea (0.3:1, 0.6:1 ratios) pre-treated and acidulated
Arginine (0.3:1, 0.6:1 ratios) pre-treated and acidulated
Aqueous ammonia (1:1, overload) pre-treated and acidulated

### Washing:

All samples were washed by vacuumed filtration and monitored by pH and EC. Samples were then dried in the oven at 70° C. overnight. Samples were weighed and then partitioned to be analyzed via combustion analysis to measure the retained nutrients.

Available/exchangeable N (including ammonium, nitrate, and nitrite) in the samples were extracted with DI water, 2 M KCl and 0.5 M KCl using the Extraction of Available N from Soil Sample SOP.

### Results:

As shown in Table 4, the total Nitrogen (N) content of the acidulated samples increases as the urea pre-treatment concentration increases from 0.3:1 ratio to 0.6:1 urea:biomass ratio and finally to 1:1 urea:biomass ratio. At all urea concentrations, the washed samples have similar N content as their before ammoniated counterparts. This signifies that the nitrogen from the urea is bound to the carbon matrix of the acidulated pinewood shaving, thereby retaining the N even after washing.

Table 4 also shows a higher N retention of the ammoniated washed samples at 0.3:1 urea:biomass ratio and 0.6:1 urea:biomass ratio when compared to non-ammoniated washed samples of the same respective concentrations. This increased N retention after ammoniation and washing was also observed in the arginine pre-treatment sample. Without being limited to any particular theory or mechanism of action, the higher N retention of the ammoniated samples after wash may be explained by the ammonium (NH₄⁺) cation from the aqueous ammonia forming an ionic bond with the negative sites of the acidulated carbon. The nitrogen difference of the 0.3:1 urea:biomass ratio and 0.6:1 urea:biomass ratio pre-treatments are 30% and 36%, respectively, of the original nitrogen content prior to washing.

In Table 4, the arginine pre-treatments were observed to have a lower total N content overall. Unlike the increasing urea concentration pre-treatments, the arginine pre-treatments only had a slight increase in total N with increasing arginine concentration. This can be explained by the lower N content in arginine versus urea and the other pre-treatments.

Table 4 shows that the lysine and polyacrylamide pre-treatments have a low N content after acidulation and have little to no N content after washing, suggesting that there was no binding of N to the carbon matrix.

The results shown in Table 4 suggest that the chemical structure of the pre-treatment source contains an activated carbonyl, for instance in urea, or an imine group, for instance in arginine. Not to be held to a theory, but during carbonization, oxygen moieties on the surface of the carbon are created as alcohols or carboxylic acids which chemically react with the pre-treatment chemical to form carbamate-like bonds to the carbon surface, binding to the nitrogen source. Other pre-treatments such as ammonia or lysine do not have these activated carbonyls or imine groups and show little to no retention of nitrogen in the washed samples.

TABLE 4
Combustion analysis results of the acidulated, ammoniated and washed
pine wood shavings pre-treated with urea, arginine, lysine, aqueous
ammonia, or polyacrylamide at various concentrations.

| | | Combustion Analysis | | |
|---|---|---|---|---|
| | Pre-Treated Biomass | (%) | | |
| Pre-Treatment | Treatment | TC | TN | TS |
| 0.3:1 urea:biomass | Acidulated | 33 | 6.1 | 13* |
| 0.3:1 urea:biomass | Acidulated then Washed | 47 | 6.7 | 3.8 |
| 0.3:1 urea:biomass | Acidulated and Ammoniated | 33 | 38 | 8.7 |
| 0.3:1 urea:biomass | Acidulated and Ammoniated | 56 | 10 | 4.0 |
| | then Washed | | | |
| 0.6:1 urea:biomass | Acidulated | 37 | 9.7 | 16* |
| 0.6:1 urea:biomass | Acidulated then Washed | 45 | 9.1 | 5.3 |
| 0.6:1 urea:biomass | Acidulated and Ammoniated | 38 | 42 | 6.5 |
| 0.6:1 urea:biomass | Acidulated and Ammoniated | 43 | 12 | 5.7 |
| | then Washed | | | |
| 1:1 urea:biomass | Acidulated | 21 | 12 | 15* |
| 1:1 urea:biomass | Acidulated then Washed | 48 | 11 | 6 |
| 0.3:1 arginine:biomass | Acidulated | 33 | 4.4 | 10* |
| 0.3:1 arginine:biomass | Acidulated then Washed | 43 | 6.8 | 5.6 |
| 0.3:1 arginine:biomass | Acidulated and Ammoniated | 35 | 35 | 7.9 |
| 0.3:1 arginine:biomass | Acidulated and Ammoniated | 48 | 12 | 6.0 |
| | then Washed | | | |
| 0.6:1 arginine:biomass | Acidulated | 18 | 5.5 | 16 |
| 0.6:1 arginine:biomass | Acidulated and Ammoniated | 23 | 32 | 8.4* |
| 0.6:1 arginine:biomass | Acidulated and Ammoniated | 40 | 10 | 4.7 |
| | then Washed | | | |
| 0.3:1 lysine:biomass | Acidulated | 39 | 3.2 | 11* |
| 0.3:1 lysine:biomass | Acidulated then Washed | 47 | 0.96 | 5.4 |
| 0.6:1 lysine:biomass | Acidulated | 32 | 3.3 | 11* |
| 0.6:1 lysine:biomass | Acidulated then Washed | 50 | 1.1 | 5.5 |
| 1:1 lysine:biomass | Acidulated | 24 | 4.8 | 11* |
| 1:1 lysine:biomass | Acidulated then Washed | 41 | 0.93 | 4.7 |
| 0.3:1 polyacrylamide:biomass | Acidulated | 29 | 0.74 | 12* |
| 0.3:1 polyacrylamide:biomass | Acidulated then Washed | 52 | 3.2 | 5.0 |

*indicates that the sample exceeded the calibration range.

Table 5 shows that the duration of soaking time for the 0.6:1 urea:biomass and 1:1 urea:biomass pre-treatment solutions had a minimal effect on the N content after acidulation. The acidulated samples of the 0.6:1 urea:biomass at all soak times: 1 day, 3 days, 1 week and 4 weeks, initially had an N content around the 8-10% range but after washing, it was shown that the 1-day soak and the 3-day soak have a higher N content than soaking for longer than 1 week.

TABLE 5
Combustion analysis results of the acidulated and washed pine
wood shavings pre-treated with 0.6:1 urea:biomass or 1:1 urea:biomass
urea solutions with various pre-treatment soak time.

| | Combustion Analysis (%) | | |
|---|---|---|---|
| Sample | TC | TN | TS |
| 0.6:1 urea:biomass - 1 Day Soak | 20 | 8.5 | 16* |
| 0.6:1 urea:biomass - 1 Day Soak - | 47 | 8.5 | 3.1 |
| Washed | | | |
| 0.6:1 urea:biomass - 3 Days Soak | 37 | 9.7 | 16* |
| 0.6:1 urea:biomass - 3 Days Soak - | 45 | 9.1 | 5.3 |
| washed | | | |
| 0.6:1 urea:biomass - 1 Week | 40 | 10 | 12* |
| Soak | | | |
| 0.6:1 urea:biomass - 1 Week | 68 | 6.7 | 6.3 |
| Soak - Washed | | | |
| 0.6:1 urea:biomass - 4 Weeks | 47 | 9.3 | 14* |
| Soak | | | |
| 0.6:1 urea:biomass - 4 Weeks | 18 | 6.3 | 3.5 |
| Soak - Washed | | | |
| 1:1 urea:biomass - 1 Day Soak | — | — | — |
| 1:1 urea:biomass - 1 Day Soak - | 45 | 12 | 8.3* |
| Washed | | | |
| 1:1 urea:biomass - 3 Days Soak | 21 | 12 | 15* |
| 1:1 urea:biomass - 3 Days Soak - | 48 | 11 | 6.0 |
| Washed | | | |

*indicates that the sample exceeded the calibration range.

Table 6 shows the total N content of the CCT pre-treated with 0.6:1 urea:biomass solution when washed with DI water or 2 M KCl. The 2 M KCl-washed sample had a higher N content than the DI water-washed sample and the acidulated washed sample. This suggests that the N and S are tightly (i.e., covalently) bound in the carbon matrix as any ionically bound nitrogen would be removed with the KCl wash.

TABLE 6
Combustion analysis results of CCT pre-treated with
0.6:1 urea:biomass, washed with DI water and 2M KCl.

Combustion Analysis (%)

| Sample | TC | TN | TS |
|---|---|---|---|
| 0.6:1 urea:biomass, Acidulated - | 45 | 9.1 | 5.3 |
| Washed | | | |
| 0.6:1 urea:biomass, Acidulated | 43 | 12 | 5.7 |
| then Ammoniated - DI Water | | | |
| Washed | | | |
| 0.6:1 urea:biomass, Acidulated | 35 | 15 | 7.5 |
| then Ammoniated - 2M KCl | | | |
| Washed | | | |

The Ion Chromatography results of the extracted filtrate of the 0.6:1 urea:biomass pre-treatment CCT sample are shown in Table 7. Increasing the concentration of the extractant solution did not seem to increase the amount of ammonium ion extracted, indicating that nitrogen is tightly bound to the carbon complex.

TABLE 7
Ion Chromatography (IC) results of the 0.6:1 urea:biomass
pre-treatment CCT extraction. The sample was extracted
with DI water, 0.5M KCl, and 2M KCl using the Extraction
of Available N from Soil Sample SOP.

| | Ion Chromatography Filtrate Results (ppm) | | |
|---|---|---|---|
| Washing Procedure | SO₄²⁻ | SO₄²⁻—S | NH₄⁺ |
| DI Water Washed | 103650.00 | 34515.45 | 2658.20 |
| 0.5M KCl Washed | 103116.30 | 34337.73 | 2809.54 |
| 2M KCl Washed | 89903.55 | 29937.88 | 2730.12 |

In summary, the urea pre-treatment prevails among all other pre-treatments in retaining the highest total N content after wash. From the 2 M KCl extraction of the 0.6:1 urea:biomass pre-treated sample, it is suggested that the nitrogen is strongly bound to the porous carbon matrix.

### Example 3: Effect of Order of Addition of Hydrogen Peroxide to the Carbonaceous Biomass Pre-Treatment Methods

Experiments were conducted to investigate the effect of hydrogen peroxide addition prior to nitrogen treatment on the nutrient retention of the resulting porous carbon matrix product.

Solutions of varying concentrations of hydrogen peroxide were tested as a pre-treatment for carbonaceous biomass samples (i.e., pinewood shavings) at concentrations of 15%, 30% and 50% w/w with the subsequent addition of a urea solution (0.6:1 urea:biomass on a dry weight basis) followed by acidulation.

During the acidulation, sulfuric acid (1:1 acid:biomass by weight) was slowly added to the pinewood shavings. The resulting acidulated porous carbon matrix samples were slowly stirred with a glass rod by hand for 5 minutes or until all the pinewood shavings were coated/reacted.

The nitrogen treated and acidulated porous carbon matrix samples were slowly added aqueous ammonia solution and stirred with a glass rod by hand for 5 minutes or until all the pinewood shavings were coated/reacted to neutralize the residual acid. The highest temperature of the ammoniation reaction was recorded. Samples were then partitioned to be analyzed by combustion analysis. Sample were dried at 70° C. overnight prior to combustion analysis.

The samples were then washed using vacuum filtration, and monitored by pH and EC to ensure thorough washing. Samples were then dried in the oven at 70° C. overnight. Samples were weighed and then partitioned to be analyzed via combustion analysis.

### Results:

As shown in Table 8, the total retained nitrogen (N) content of the acidulated samples increased with the addition of 15% hydrogen peroxide, but then only slightly increased as the peroxide was increased to 30% and 50%. This suggests that the addition of oxygen functionality on the surface of the carbon increases the retention of N. This would further signify that the N is being bound to the carbon surface through oxygen moieties as previously suggested.

TABLE 8
Effect of hydrogen peroxide pre-treatment.

| | Combustion Analysis (%) | | |
|---|---|---|---|
| Pre-treated Biomass | C | N | S |
| 0.6:1 urea:biomass, Acidulated | 37 | 9.7 | 16* |
| 0.6:1 urea:biomass, Acidulated - Washed | 45 | 9.1 | 5.3 |
| 0.6:1 urea:biomass, Acidulated then Ammoniated - Washed | 43 | 12 | 5.7 |
| 0.6:1 urea:biomass with 15% Hydrogen Peroxide, | 44 | 20 | 6.8 |
| Acidulated | | | |
| 0.6:1 urea:biomass with 15% Hydrogen Peroxide, | 33 | 12 | 11* |
| Acidulated - Washed | | | |
| 0.6:1 urea:biomass with 30% Hydrogen Peroxide, | 44 | 21 | 7.9 |
| Acidulated | | | |
| 0.6:1 urea:biomass with 30% Hydrogen Peroxide, | 46 | 10 | 8.7* |
| Acidulated - Washed | | | |
| 0.6:1 urea:biomass with 30% Hydrogen Peroxide, | 43 | 11 | 9.4* |
| Acidulated then Ammoniated - Washed | | | |
| 0.6:1 urea:biomass with 50% Hydrogen Peroxide, | 51 | 20 | 8.9* |
| Acidulated | | | |
| 0.6:1 urea:biomass with 20% Hydrogen Peroxide | 39 | 13 | 7.7 |
| Acidulated, Acidulated Then Ammoniated - Washed | | | |

### Example 4: Effect of Moisture on the Carbonaceous Biomass Pre-Treatment Methods

Experiments were conducted to investigate the effect of drying prior to acidulation on the nutrient retention of the resulting porous carbon matrix product.

Urea solution was added to biomass samples prior to acidulation to achieve a 0.6:1 urea:biomass ratio and soaked for 1 hour. The pre-treated samples were then either acidulated directly or dried overnight at 70° C. prior to acidulation.

Sulfuric acid was slowly added to the pre-treated pinewood shavings at 1:1 pre-treated biomass to sulfuric acid ratio. The resulting acidulated porous carbon matrix sample was slowly stirred with a glass rod by hand for 5 minutes or until all the pinewood shavings were coated/reacted. The highest temperature of the acidulation reaction was recorded.

The pre-treated and acidulated porous carbon matrix samples were slowly added Aq. Ammonia at a ratio of 1:1 Aq. Ammonia:biomass (by weight) and stirred with a glass rod by hand for 5 minutes or until all the pinewood shavings were coated/reacted to neutralize the residual acid. The CCT samples were then partitioned to be analyzed by combustion analysis. Samples were dried at 70° C. overnight prior to combustion analysis.

To measure the retained nitrogen and sulfur contained within the sample, available/exchangeable N (including ammonium, nitrate, nitrite, and soluble organic-N) in the CCT was extracted with DI water using the Extraction of Available N from Soil Sample SOP.

### Results:

As shown in Table 9, drying the pre-treated material at 70° C. overnight prior to acidulation had little effect on the nutrient analysis of the final sample after ammoniation. A slight difference in the reactivity of the acidulation was observed, but this did not lead to a significant change in the nutrient analysis of the amount of retained nitrogen.

TABLE 9
Combustion and N retention results on the
effect of moisture content on acidulation.

| | Combustion results | | | C bound N |
|---|---|---|---|---|
| | TN | TS | TC | % of original |
| Sample | % | | | N |
| 0.6:1 urea:biomass, Dried, Acidulated with | 22.8 | 16.8 | 12.2 | 37.7* |
| Sulfuric Acid (1:1), Ammoniated with Aq. | | | | |
| Ammonia (1:1) | | | | |
| 0.6:1 urea:biomass, NOT Dried, Acidulated with | 22.5 | 15.9 | 12.1 | 41.2* |
| Sulfuric Acid (1:1), Ammoniated with Aq. | | | | |
| Ammonia (1:1) | | | | |

*indicates analysis by the persulfate method.

### Example 5: Effect of Order of Addition of Nitrogen Treatment to the Carbonaceous Biomass

Experiments were conducted to investigate the effect of order of addition of the nitrogen treatment on the nutrient retention of the resulting porous carbon matrix product.

Urea solution was added to biomass samples (i.e., pinewood shavings) prior to acidulation and allowed to soak, or after acidulation, to achieve a 0.6:1 urea:biomass ratio. During the acidulation, sulfuric acid was slowly added to the pinewood shavings. The resulting acidulated porous carbon matrix sample was slowly stirred with a glass rod by hand for 5 minutes or until all the pinewood shavings were coated/reacted.

The nitrogen treated and acidulated porous carbon matrix samples were slowly added aqueous ammonia solution and stirred with a glass rod by hand for 5 minutes or until all the pinewood shavings were coated/reacted to neutralize the residual acid. CCT samples were then partitioned to be analyzed by combustion analysis. Samples were dried at 70° C. overnight prior to combustion analysis.

To measure the retained nitrogen and sulfur contained within the sample, available/exchangeable N (including ammonium, nitrate, nitrite, and soluble organic-N) in the CCT was extracted with DI water using the Extraction of Available N from Soil Sample SOP.

### Results:

As shown in Table 10, the amount of nitrogen retained within the porous carbon matrix sample after ammoniation was similar regardless of whether the urea solution (at a ratio of 0.6:1 urea:biomass by weight) was added before or after acidulation.

TABLE 10
Combustion analysis results of the acidulated and ammoniated
CCT samples with N-treatment either before or after acidulation
and the effect of order of addition of urea.

| | Combustion results | | | C bound N |
|---|---|---|---|---|
| | TN | TS | TC | % of original |
| Sample | % | | | N |
| Treated with Urea Solution | 22.5 | 15.9 | 12.1 | 41.2* |
| (0.6:1 urea:biomass) | | | | |
| Before Acidulation | | | | |
| Treated with Urea Solution | 22.4 | 16.3 | 12.4 | 41.9* |
| (0.6:1 urea:biomass) | | | | |
| After Acidulation | | | | |

*indicates analysis by the persulfate method.

### Example 6: Effect of Temperature on Acidulation and Ammoniation

Experiments were conducted to investigate the effect of temperature on the retention of nitrogen in the ammoniated sample.

Urea solution was added to biomass samples (i.e., pinewood shavings) prior to acidulation to achieve a 0.6:1 urea:biomass ratio, and allowed to soak for 1 hour. The temperature of the biomass was then either kept at room temperature (RT) and allowed to increase during acidulation (temperature of reaction was not manipulated) or the temperature of reaction was maintained at 40° C. during acidulation. During acidulation, sulfuric acid was slowly added to the pinewood shavings and slowly stirred with a glass rod by hand for 5 minutes or until all the pinewood shavings were coated/reacted.

The pretreated and acidulated porous carbon matrix samples were slowly added aqueous ammonia solution either at RT and allowed to increase with temperature during ammoniation (temperature of reaction was not manipulated) or kept at 40° C. and stirred with a glass stir rod by hand for 5 minutes or until all the acidulated material was coated/reacted to neutralize the residual acid. Samples were then partitioned to be analyzed by combustion analysis. Samples were dried at 70° C. overnight prior to combustion analysis.

To measure the retained nitrogen and sulfur contained within the sample, available/exchangeable N (including ammonium, nitrate, nitrite, and soluble organic-N) in the CCT was extracted with DI water using the Extraction of Available N from Soil Sample SOP.

### Results:

As shown in Table 11, a lower temperature when the urea solution is mixed with the acid can be observed to lead to a higher retained nitrogen. When acidulated and ammoniated at 40° C., the retained nitrogen is about 60% compared to when both the acidulation and ammoniation is allowed to reach the increased temperature of reaction. In the other samples, when the temperature of ammoniation is kept constant at 40° C. and the acidulation temperature is allowed to increase, the retained nitrogen also is shown to increase when the temperature is kept lower.

TABLE 11
Combustion and N Retention results on the effect
of temperature on acidulation and ammoniation.

| | Combustion results | | | C bound N |
|---|---|---|---|---|
| | TN | TS | TC | % of original |
| Sample | % | | | N |
| 0.6:1 urea:biomass, Dried, Acidulated with | 22.8 | 16.8 | 12.2 | 37.7* |
| Sulfuric Acid (1:1), Ammoniated with Aq. | | | | |
| Ammonia (1:1), Reaction Temperature of | | | | |
| Acidulation and Ammoniation not Manipulated | | | | |
| 0.6:1 urea:biomass, Dried, Acidulated with | 23.7 | 9.8 | 23.2 | 60.4* |
| Sulfuric Acid (1:1), Ammoniated with Aq. | | | | |
| Ammonia (1:1), Reaction Temperature of | | | | |
| Acidulation and Ammoniation Maintained at 40° C. | | | | |
| 0.6:1 urea:biomass, NOT Dried, Acidulated with | 21.9 | 15.9 | 13.5 | 50.7* |
| Sulfuric Acid (1:0.8), Ammoniated with Aq. | | | | |
| Ammonia (1:1), Reaction Temperature of | | | | |
| Acidulation and Ammoniation Maintained 40° C. | | | | |
| 0.6:1 urea:biomass, NOT Dried, Acidulated with | 22.1 | 15.2 | 14.9 | 43.7* |
| Sulfuric Acid (1:0.8), Ammoniated with Aq. | | | | |
| Ammonia (1:1), Reaction Temperature of Only | | | | |
| Ammoniation Maintained at 40° C. | | | | |

*indicates analysis by the persulfate method.

As shown in Table 12, a similar trend between temperature and nitrogen retention was observed. After acidulation, the urea solution was shown to have a higher nitrogen retention when the urea and acid were added at lower temperature. Additionally, the temperature of ammoniation also appears to significantly affect nitrogen retention.

TABLE 12
Combustion and N retention results on the effect
of temperature on acidulation and ammoniation.

| | Combustion results | | | C bound N |
|---|---|---|---|---|
| | TN | TS | TC | % of original |
| Sample | % | | | N |
| Biomass Acidulated with Sulfuric Acid (1:1.3) | 22.4 | 14.6 | 15.4 | 56.5* |
| At RT, Then Added Urea Solution (0.6:1 | | | | |
| urea:biomass), Ammoniated with Aq. Ammonia | | | | |
| (1:1), Reaction Temperature of Acidulation and | | | | |
| Ammoniation Not Manipulated | | | | |
| Biomass Acidulated with Sulfuric Acid (1:1.3) | 22.4 | 16.3 | 12.4 | 41.9* |
| At RT, Then Added Urea Solution (0.6:1 | | | | |
| urea:biomass), Ammoniated with Aq. Ammonia | | | | |
| (1:1), Reaction Temperature of Only Acidulation | | | | |
| Maintained at 40° C. | | | | |
| Biomass Acidulated with Sulfuric Acid (1:1.3) | 23.1 | 9.9 | 22.7 | 60.2* |
| At RT, Then Added Urea Solution (0.6:1 | | | | |
| urea:biomass), Ammoniated with Aq. Ammonia | | | | |
| (1:1), Reaction Temperature of Acidulation and | | | | |
| Ammoniation Maintained at 40° C. | | | | |

*indicates analysis by the persulfate method.

### Example 7: Effect of Other Acids on Nitrogen Retention

Experiments were conducted to investigate the effect of other acids on nitrogen retention of the resulting porous carbon matrix product.

Urea solution was added to biomass samples (i.e., pinewood shavings) prior to acidulation to achieve a 0.6:1 urea:biomass ratio and allowed to soak for 1 hour. The temperature of the biomass was then either kept at RT and allowed to increase during acidulation (temperature of reaction was not manipulated) or the temperature of reaction was maintained at 40° C. during the acidulation. The acidulation was achieved with sulfuric acid (SA) and phosphoric acid (PA) where the SA was added first and allowed to react, followed by the PA. The resulting acidulated porous carbon matrix sample was slowly stirred with a glass rod by hand for 5 minutes or until all the material was coated/reacted.

The pre-treated and acidulated porous carbon matrix samples were slowly added aqueous ammonia solution and kept at 40° C. and stirred with a glass rod by hand for 5 minutes or until all the material was coated/reacted to neutralize the residual acid. Samples were then partitioned to be analyzed by combustion analysis. Samples were dried at 70° C. overnight prior to combustion analysis.

To measure the retained nitrogen and sulfur contained within the sample, available/exchangeable N (including ammonium, nitrate, nitrite and soluble organic-N) in the CCT was extracted with DI water using the Extraction of Available N from Soil Sample SOP.

### Results:

As shown in Table 13, a mixture of acids can be used to produce a product with retained nitrogen. It is observed in this sample that temperature of the reaction does not affect the retained nitrogen possibly due to the mixture of the acids.

TABLE 13
Combustion and N retention results on the effect of adding other mineral acids.

| | Combustion results | | | C bound N |
|---|---|---|---|---|
| | TN | TS | TC | % of original |
| Sample | % | | | N |
| 0.6:1 urea:biomass, NOT Dried, Acidulated with | 21.1 | 13.0 | 8.6 | 27.8* |
| SA (1:0.8) and PA (1:0.5), Ammoniated with Aq. | | | | |
| Ammonia (1:1), Reaction Temperature of | | | | |
| Acidulation and Ammoniation Maintained at 40° C. | | | | |
| 0.6:1 urea:biomass, NOT Dried, Acidulated with | 21.0 | 12.0 | 9.6 | 28.6* |
| SA (1:0.8) and PA (1:0.5), Ammoniated with Aq. | | | | |
| Ammonia (1:1), Reaction Temperature of Only | | | | |
| Ammoniation Maintained at 40° C. | | | | |

*indicates analysis by the persulfate method.

### Example 8: Effect of Adding Metals on Nitrogen Retention

Experiments were conducted to investigate the addition of metals as a pre-treatment on the nutrient retention of the resulting porous carbon matrix product.

The biomass samples were added either to an iron sulfate or zinc chloride solution and allowed to soak for 1 hour. Acidulation was achieved with sulfuric acid which was slowly added to the pinewood shavings. The resulting acidulated porous carbon matrix sample was slowly stirred with a glass rod by hand for 5 minutes or until all the material was coated/reacted.

The pretreated and acidulated porous carbon matrix samples were then added to a urea solution (0.6:1 urea:biomass ratio by weight) followed by an aqueous ammonia solution and stirred with a glass stir rod by hand for 5 minutes or until all the material was coated/reacted to neutralize the residual acid. Samples were then partitioned to be analyzed by combustion analysis. Samples were dried at 70° C. overnight prior to combustion analysis.

To measure the retained nitrogen and sulfur contained within the sample, available/exchangeable N (including ammonium, nitrate, nitrite and soluble organic-N) in the CCT was extracted with DI water using the Extraction of Available N from Soil Sample SOP.

### Results:

As shown in Table 14, the pre-treatment of metals resulted in the retention of nitrogen within the carbon matrix. When iron sulfate was used, retention of both the urea and ammonia was observed. The ammonia retention is possible with complexation with iron within the carbon matrix. No other metals tested retained ammonia. When zinc chloride was used to pre-treat the biomass, retention was observed with the addition of the urea solution, but not with just the ammonia. This would suggest that iron sulfate complexes more with ammonia than zinc chloride.

TABLE 14
Combustion and N retention results on the
effect of adding metals as a pre-treatment.

| | Combustion results | | | C bound N |
|---|---|---|---|---|
| | TN | TS | TC | % of original |
| | % | | | N |
| 10% Iron Sulfate, NOT Dried, Acidulated with | 9.9 | 11.7 | 5.5 | 12.9* |
| SA (1:0.8), Ammoniated with Aq. Ammonia | | | | |
| (1:1), Reaction Temperature of Acidulation and | | | | |
| Ammoniation not Manipulated | | | | |
| 10% Iron Sulfate, NOT Dried, Acidulated with | 22.1 | 16.9 | 29.8 | 39.3* |
| SA (1:0.8), Added Urea Solution (0.6:1 | | | | |
| urea:biomass), Ammoniated with Aq. Ammonia | | | | |
| (1:1), Reaction Temperature of Acidulation and | | | | |
| Ammoniation Not Manipulated | | | | |
| 10% Zinc Chloride, NOT dried, Acidulated with | 9.7 | 11.2 | 6.7 | 0.4* |
| SA (1:0.8), Ammoniated with Aq. Ammonia | | | | |
| (1:1), Reaction Temperature of Acidulation and | | | | |
| Ammoniation Not Manipulated | | | | |
| 10% Zinc Chloride, NOT Dried, Acidulated with | 19.8 | 16.1 | 8.4 | 43.8* |
| SA (1:0.8), Added Urea Solution (0.6:1 | | | | |
| urea:biomass), Ammoniated with Aq. Ammonia | | | | |
| (1:1), Reaction Temperature of Acidulation and | | | | |
| Ammoniation Not Manipulated | | | | |

*indicates analysis by the persulfate method.

### Example 9: Effect of Adding Temperature on Nitrogen Retention

Experiments were conducted to investigate the effect of adding temperature at different durations on the nitrogen retention of the resulting porous carbon matrix product.

The biomass samples (i.e., pinewood shavings) were added a urea solution (2:1 urea:biomass by weight) either prior to acidulation and allowed to soak, or after acidulation. During the acidulation, sulfuric acid (0.25:1 to 1:1 acid:biomass) was slowly added to the pinewood shavings and slowly stirred with a glass rod to ensure all the shavings were coated. The coated biomass was then either allowed to increase in temperature due to the exotherm and cool back to room temperature after reaction or put in the oven to hold the exotherm at various temperatures for various periods of time. The acidulations were maintained at different temperatures including 150° C., 250° C. and no external heat added, for a duration of 3-24 hours. The temperatures chosen were all at or under 250° C.

After they were allowed to cool, the nitrogen treated and acidulated porous carbon matrix samples were slowly added aqueous ammonia solution (1:1 Aq. Ammonia:biomass by weight) and stirred with a glass rod by hand for 5 minutes or until all the pinewood shavings were coated/reacted to neutralize the residual acid. CCT samples were then partitioned to be analyzed by combustion analysis. Samples were dried at 70° C. overnight prior to combustion analysis.

To measure the retained nitrogen and sulfur contained within the sample, available/exchangeable N (including ammonium, nitrate, nitrite, and soluble organic-N) in the CCT was extracted with DI water using the Extraction of Available N from Soil Sample SOP.

### Results:

Table 15 shows a comparison of nutrient analysis between the CCT products produced by the urea treatments before or after acidulation at different temperatures. The addition of urea after acidulation, with acidulation maintained at a temperature of 150° C., yielded the highest TN concentration (30.6%) in the CCT products. However, the highest C bound N (82.2%) was achieved when urea was added before acidulation at 250° C. Addition of heat to the acidulation reaction also produced a higher carbon concentration in the CCT products, with a greater proportion of the carbon in a more stable form. This compares to a higher portion of labile carbon when no heat was added. Changes in the production process involving the acid:biomass ratio along with the temperature and duration of temperature, could be refined to alter the proportion of stable and labile carbon in the CCT products as well as to ensure carbonization of the biomass.

TABLE 15
Combustion analysis results of the acidulated and ammoniated pine wood shavings treated
with urea. Samples were prepared using various methodology as indicated below.

| | | | | | | | | C |
|---|---|---|---|---|---|---|---|---|
| | Production Process | | | | | | | Bound |
| | | Heat Used/ | | | | | | N |
| | Urea | Temperature | Acid:Biomass | Duration Of | Combustion | | | % of |
| | Solution | (° C.) Of | Ratio | Acidulation | Analysis (%) | | | Original |
| Products | Added | Acidulation | (W/W) | (Hours) | TN | TS | TC | N |
| CCT 153 | Before | Yes/150 | 0.25:1 | 24 | 24.1 | 3.3 | 29.9 | 68.4 |
| | Acidulation | | | | | | | |
| CCT 154 | Before | Yes/250 | 0.25:1 | 3 | 22 | 4.1 | 35.4 | 82.2 |
| | Acidulation | | | | | | | |
| CCT 165 | Before | No/22 | 1:1 | 24 | 28 | 7.9 | 20 | 18.3 |
| | Acidulation | | | | | | | |
| CCT 159 | After | Yes/150 | 0.25:1 | 24 | 30.6 | 1.1 | 30.2 | 13.6 |
| | Acidulation | | | | | | | |
| CCT 510 | After | No/22 | 1:1 | 24 | 22.4 | 14.6 | 15.4 | 56.5* |
| | Acidulation | | | | | | | |

*indicates analysis by the persulfate method.

### Example 10: Measurement of Ammonia Volatilization Reduction in Nitrogen Treated CCT Products

Experiments were conducted to investigate if the CCT samples prepared with urea treatment by various methods affect the ammonia volatilization.

### Preparation of Soil Incubation for Ammonia Volatilization Measurement.

Sandy loam soil (68% sand, 20% silt and 12% clay) was collected from the surface (0-10 cm) of agricultural land in multiple locations near Lethbridge, AB, Canada. The collected soil had alkaline pH (between 7.5 and 7.8 in 1:2 soil water extraction) with organic matter of 1.3 to 1.7% and cation exchange capacity (CEC) of 21.6 to 28.6 meq/100 g. After removing coarse root material, the soil was sieved through a 2 mm sieve. A sub sample of the soil was used for determining chemical and physical characteristics. The air-dry soil was hydrated to 30% water filled pore space (WFPS) moisture content and pre-incubated in bulk for 48 hours. After pre-incubation, 100 g soil (oven dry equivalent) was placed in 1 L mason jars prior to treatment applications. The fertilizer treatments (urea and N-treated CCT samples) were surface applied to the soil to simulate broadcast application in the field at 22.5 mg N/100 g soil. Each treatment was replicated three times. Data presented in the tables and figures represent the mean of three replications with a standard deviation. Urea granules (46-0-0; Greenfield) and CCT-Nitro products (See Table 15 for nutrient analysis) were crushed to a similar size before application. The jars were closed tightly with a lid and connected to a closed chamber system described below for ammonia volatilization measurements.

### Measuring Ammonia Volatilization:

Ammonia volatilization was measured in a closed chamber system with a constant air flow, with minor modifications to published methods (Miles, 2008 and Woodward, 2008). In brief, ammonia volatilized from the soil surface was trapped in a boric acid solution (0.2 M) and the concentration of ammonia trapped in boric acid was determined by IC or EC. Ammonia volatilization techniques have been described in Miles, 2008 and Woodward, 2008. The soil and fertilizer treatments in the mason jars were then incubated at 25° C. in a closed chamber with a constant air flow of 0.2 L/min. Two sets of boric acid traps (each containing 35 ml of boric acid in 50 ml size tubes) were used to trap any ammonia gas being emitted from the soil. The second boric acid trap was included to ensure that no ammonia escaped due to possible saturation of the boric acid in the first trap. Boric acid in the traps was changed daily to avoid saturation and ammonia concentration in the collected boric acid was measured. Daily ammonia volatilization was calculated by the sum of ammonia trapped in two sets of boric acid. Ammonia volatilization was measured for the first 8 days of incubation.

### Results:

Table 16 shows the cumulative ammonia (NH₃) volatilization loss from urea and CCT products disclosed in Table 15 in the first 8 days after application to soil. Among the four CCT products with different production methods, CCT 153 and 154 had the greatest reductions in ammonia volatilization; 61% to 82% compared to urea. These products had urea addition before acidulation at temperatures of 150° C. and 250° C., respectively, with an acid to biomass ratio of 0.25:1. Reductions in ammonia volatilization were not observed when no heat was added (CCT 165) and the acid to biomass ratio was 1:1. An acidulation period of more than 3 hours had little effect on volatilization. The soil with low CEC had increased volatilization compared to the high CEC soil for urea but not for CCT 153.

Urea was dissolved in the soil solution after it was applied to the soil and then hydrolyzed into carbon dioxide and ammonium ions by urease enzymes present in the soil. Ammonia volatilization occurs when ammonium ions convert into ammonia in the soil solution due to the alkalinity (pH>7), and the high concentration of ammonium within the soil solution. Ammonia then diffuses out of soil and is lost to the air and collected in the boric acid traps. Losses were found to be as high as 33% in the alkaline sandy loam soil (shown in the Table 16) but can be higher or lower in other soil types. Without being limited to any particular theory or mechanism of action, it appears that in the CCT products where urea was added before acidulation with the addition of heat, the urea bonded with the porous carbon matrix more tightly, or in a form inaccessible to the urease enzyme resulting in less N released into the soil solution thereby reducing ammonium within the soil and subsequent loss as volatilized ammonia. The avoidance of urease degradation of N attached to the carbon matrix resulted in a substantial decrease in ammonia volatilization from CCT 153 and 154.

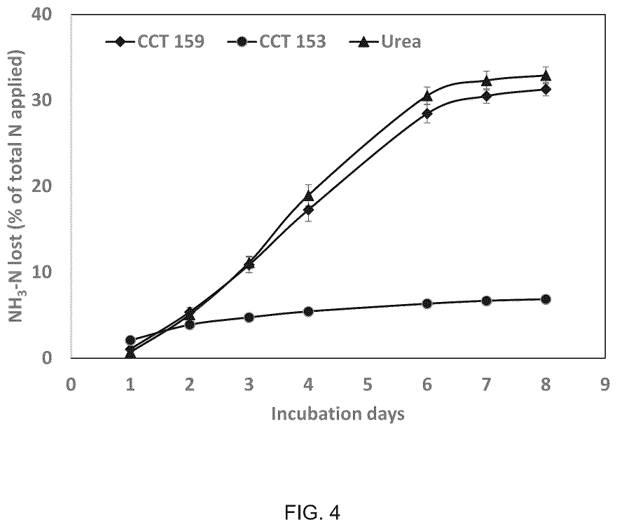

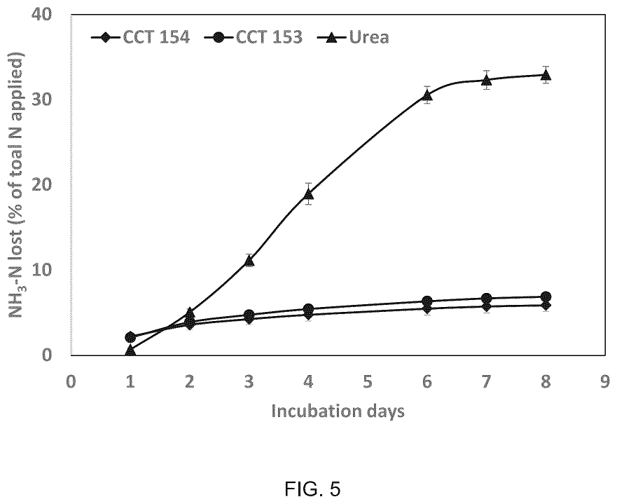

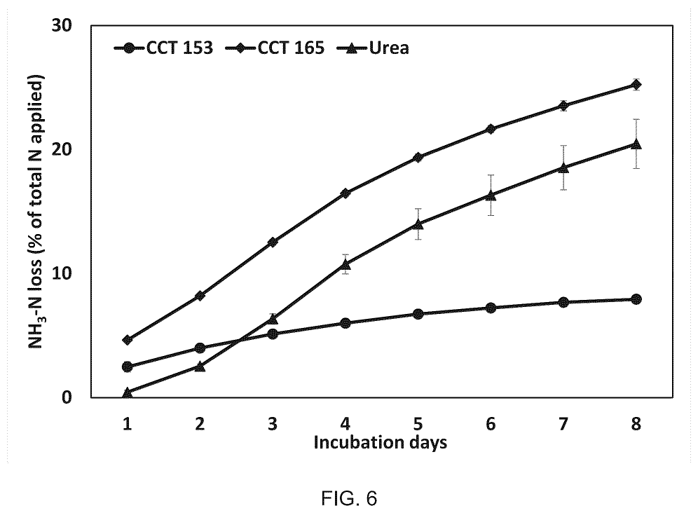

Cumulative ammonia volatilization in Table 16 and FIGS. 4-6 show that an introduction of urea before acidulation and the addition of heat during acidulation reduced ammonia volatilization. Increasing temperature from 150° C. to 250° C. during acidulation had little impact and suggests that the addition of heat, or holding the exotherm of the acidulation reaction for a period of time with urea added before acidulation binds the nitrogen more tightly to the porous carbon matrix.

TABLE 16
Cumulative ammonia volatilization loss from urea and CCT products.

| | | | | Cumulative NH₃ Volatilization | |
|---|---|---|---|---|---|
| | Production Process | | | (% of total N applied) | |
| | Urea | Heat Used / | Acid:Biomass | In Soil with a | In Soil with a |
| | Solution | Temperature | Ratio | Lower CEC | Higher CEC |
| Products | added | (° C.) | (W/W) | (21.6 meq/100 g) | (28.6 meq/100 g) |
| Urea | N/A | N/A / N/A | N/A | 32.9 | 20.46 |
| CCT 153 | Before | Yes / 150 | 0.25:1 | 6.9 | 7.9 |
| | Acidulation | | | | |
| CCT 154 | Before | Yes / 250 | 0.25:1 | 5.9 | ND |
| | Acidulation | | | | |
| CCT 165 | Before | No / 22 | 1:1 | ND | 25.2 |
| | Acidulation | | | | |
| CCT 159 | After | Yes / 150 | 0.25:1 | 31.3 | ND |
| | Acidulation | | | | |

ND indicates not determined.

### Example 11: Assessment of Slow-Release of N from CCT Products

Experiments were conducted to investigate various CCT products for slow-release of nitrogen.

### Preparation of Soil Incubation for Assessment of Slow-Release of N:

Slow release of N in N-treated CCT products were assessed in a laboratory incubation experiment. The experiment used a sandy loam soil as described in Example 10 and the CCT products as described in Example 9. For the incubation experiment, partially air-dried dry soil was hydrated to 40% WFPS moisture content and pre-incubated at 25° C. for 48 hours to initiate and stabilize microbial activities in the soil. After pre-incubation, 50 g soil (oven dry equivalent) was placed in 250 mL Nalgene bottles. The fertilizers including ammonium sulfate (AMS), urea, Environmentally Smart Nitrogen (ESN) and CCT products (see Table 15) were added at the rate of 12.6 mg N/100 g soil and mixed in the soil thoroughly with a spatula. No fertilizers were added in a No N control treatment. Each treatment was replicated three times. Deionized (DI) water was added to bring moisture content up to 50% WFPS. The bottles were sealed with perforated aluminum foil to allow air exchange with minimum water loss from the soil. The soil was then incubated in an incubator at 25° C. in dark for 56 days. Moisture content was maintained at 50% WFPS throughout the incubation by adding MilliQ water twice a week. Soil was destructively sampled at day 1 (after 24 hours), 7, 14, 28 and 56 of incubation. Separate bottles were prepared for each sampling time. At each sampling time, 3 bottles (each representing a replication) of each treatment were randomly selected, the soil was then extracted with DI water at 1:3 ratio (soil:water, w/w). To ensure a correct representation of the sample, all soil (50 g) in the bottle was extracted with 150 ml DI water by shaking the solution at 150 rpm in a horizontal shaker for 30 minutes. The solution was then filtered through 45 μm filter and the filtrate was analyzed in IC for extractable ammoniacal (NH₄⁺), nitrite (NO₂⁻) and nitrate (NO₃⁻) N. Nitrite was under detection limits in all the analysis. The mineral N released from the fertilizer was calculated by the sum of ammoniacal-N and nitrate-N in the extract while % N recovery was calculated as:
Percent N recovery was calculated as:

$$Total mineral N in the treatment ( \% ) = \frac{Total mineral {N}_{( trt )} - Total mineral {N}_{( control )}}{Total N applied to the soil in the treatment} \times 100$$

Percent S recovery was calculated as:

$${SO}_{4}^{--} - {S}_{trt} ( \% ) = \frac{( SO 4 - S ( trt - ) - SO 4 - S ( control ) ) \times 100}{Total S applied to the soil}$$

### Results:

Nutrient contents of previous CTT samples without treatment with a nitrogen source were in the range of 11-18% N and 11-15% S. With treatment of a nitrogen source, N content increased regardless of whether urea was added before or after acidulation, including by up to 30.6% (CCT 159) (Table 15). Addition of more nitrogen either before or after acidulation is possible to further increase the nitrogen content.

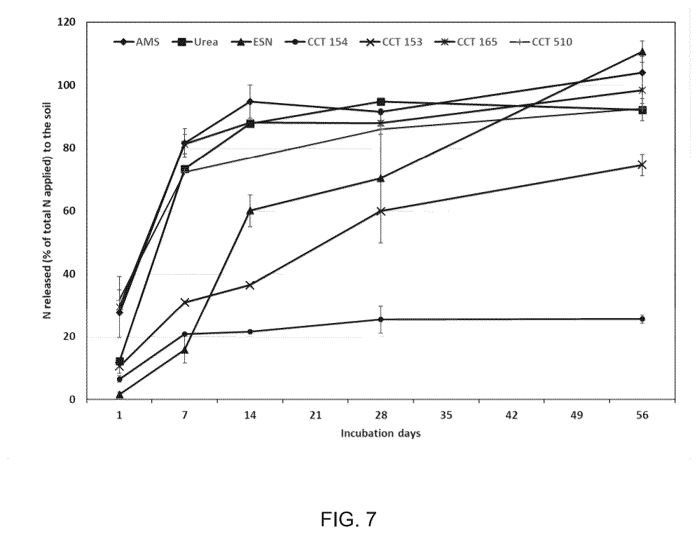

Table 17 and FIG. 7 show that N released out of CCT products after application to soil is dependent on the production method indicating that the nitrogen retained by the porous carbon matrix is in different forms depending on production method. For example, carbon can occur in either a labile or stable form. When heat is added during acidulation, more stable carbon is produced and when urea is added before acidulation, the N reacts with this stable carbon during carbonization. When this product is applied to soil, the reacted N releases more slowly than N that is soluble or N that is bound to labile carbon. In our testing, the three CCT products treated with N exhibited quite distinct patterns of N release over time in the soil. CCT 165 which was produced by adding urea solution before acidulation, but without the addition of heat, released N in a pattern similar to AMS and urea presumably because the N reacted and bound with labile carbon. A similar pattern was shown with CCT 510 which was produced by adding urea solution after acidulation. Acidulation of biomass without using external heat produced readily soluble N in the CCT products with a high proportion of labile carbon which was released similarly to that of AMS and urea. When heat was added during acidulation (CCT 154), a much lower proportion of N was released (only 25.5% of total N applied) in 56 days of incubation indicating that N was strongly retained due to the stable portion of the porous carbon matrix. Nitrogen released out of this CCT product may be too slow to meet the N uptake requirements of many crops, although it is indicative of the ability to manipulate N release rates for various cropping scenarios requiring longer N release timeframes.

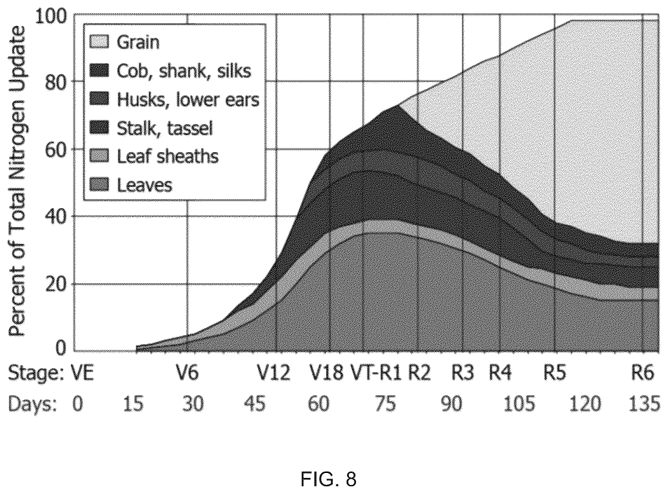

With a lower temperature of 150° C. during the acidulation process, CCT 153 demonstrated the characteristics of an agronomically effective source of slow-release N, relevant to many broad acre and horticultural crops. Nitrogen release was 10.5, 30.9, 36.4 59.9 and 74.5% of total N applied in 24 hours, 7 days, 14 days, 28 days and 56 days after application, respectively. CCT 153 contains more than 15% slow-release N when compared to AMS and urea (meeting the AAPFCO, 2011 definition for slow-release product). The results also suggest that the N released out of CCT 153 is likely effective for meeting the N demand of various crops, while minimizing risk of environmental losses. For example, modern corn hybrids take up about 60-65% of total N requirements by VT stage (65-75 day after seeding), 80-85% at R3 stage (90-95 days after seeding) and 100% by R5-R6 stage (115-120 days after seeding) (FIG. 8). Although N requirement and % N uptake varies with crops at different growth stages, CCT 153 clearly shows potential for synchronizing N release with crop demand. In this study ESN was included for reference as a commercially available slow-release product, and CCT 153 demonstrates that it prolongs slow-release characteristics over ESN, with data suggesting that production alterations involving the acid:biomass ratio along with the temperature and duration of temperature, could be refined to tailor N release patterns specific to the intended crop and geography to optimize synchronization of N release to crop demand. In ESN, N release is dependent on temperature, and the thickness of the coating, but in the CCT products, without being limited to any particular theory or mechanism of action, it appears the mode of action for N release is based on solubility and microbial activity. Furthermore, as the crop grows, roots release exudates that boost microbial activity which may cause faster release of N from the carbon matrix of CCT products.

The slow-release N characteristic of CCT is expected to have a large impact on reducing N losses through 1) leaching of nitrate; 2) gaseous loss of ammonia; 3) gaseous loss of nitrogen gas (N₂) through denitrification; and 4) gaseous loss of nitrous oxide—a potent greenhouse gas. Reducing these losses should in turn result in an increase in nitrogen use efficiency and crop yield, while simultaneously reducing negative environmental impacts from N application in agriculture.

The data in Table 17 and FIG. 7 indicate that CCT production methods should include urea addition before acidulation and addition of temperature (150° C.) to produce products with valuable slow-release potential as demonstrated in CCT 153. Urea added after acidulation during CCT production did not show any slow-release potential as demonstrated by CCT 510, although adding urea after acidulation with heat did result in a product with a higher N content. Urea addition before acidulation without additional heat CCT did not exhibit slow-release characteristics as shown in CCT 165. Although raising temperature during acidulation from ambient condition seems to be essential for retaining N in the carbon matrix, a temperature of 250° C. resulted in N release that was slower than optimal for effective agronomic performance.

Without being limited to any particular theory or mechanism of action, for CCT products pre-treated with urea solution prior to acidulation, the addition of heat to the acidulation reaction binds N to the porous carbon matrix to make a slow-release product.

TABLE 17
Cumulative N released (% of total N applied) during 56 days of soil incubation.

| | Production Process | | | | |
|---|---|---|---|---|---|
| | | Heat Used / | | | Cumulative N |
| | Urea | Temperature | | Duration of | Released by Day |
| | Solution | (° C.) of | Acid:Biomass | Acidulation | 56 (% of Total N |
| Products | Added | acidulation | Ratio (W/W) | (Hours) | Applied) |
| AMS | NA | N/A / N/A | NA | NA | 104 (5.0) |
| Urea | NA | N/A / N/A | NA | NA | 92.2 (3.5) |
| ESN | NA | N/A / N/A | NA | NA | 110.6 (3.5) |
| CCT 153 | Before | Yes / 150 | 0.25:1 | 24 | 74.6 (3.4) |
| | acidulation | | | | |
| CCT 154 | Before | Yes / 250 | 0.25:1 | 3 | 25.5 (1.3) |
| | acidulation | | | | |
| CCT 165 | Before | No / 22 | 1:1 | 24 | 98.4 (6.0) |
| | acidulation | | | | |
| CCT 510 | After | No / 22 | 1:1 | 24 | 92.5 (1.6) |
| | acidulation | | | | |

Although the disclosure has been described with reference to certain specific embodiments, various modifications thereof will be apparent to those of ordinary skill in the art. Any examples provided herein are included solely for the purpose of illustrating the disclosure and are not intended to limit the disclosure in any way. Any drawings provided herein are solely for the purpose of illustrating various aspects of the disclosure and are not intended to be drawn to scale or to limit the disclosure in any way. The scope of the claims appended hereto should not be limited by the preferred embodiments set forth in the above description but should be given the broadest interpretation consistent with the present specification as a whole. The disclosures of all documents cited herein are incorporated herein by reference as if set forth in their entirety.

### REFERENCES

1. Bender, R. R., Haegele, J. W., Ruffo, M. L. and Below, F. E., 2013. Modern corn hybrids' nutrient uptake patterns. Better crops, 97(1), pp. 7-10.
2. Brian De Borba, Richard F. Jack, and Jeffrey S. Rohrer, 2016. Determination of Total Nitrogen and Phosphorus in Wastewaters by Alkaline Persulfate Digestion Followed by IC. Thermo Fisher Scientific, Sunnyvale, CA USA.
3. Maynard, D. G. and Y. P. Kalra. 1993. Nitrogen and exchangeable ammonium nitrogen. p. 25-26. In M. R. Carter (ed.) Soil Sampling and Methods of Analysis. Lewis Publ., Boca Raton, FL.
4. Miles, D. M., Owens, P. R., Moore Jr, P. A. and Rowe, D. E., 2008. Instrumentation for evaluating differences in ammonia volatilization from broiler litter and cake. Journal of applied poultry research, 17(3), pp. 340-347.
5. Omara, P., Aula, L., Oyebiyi, F., and Raun, W. R. 2019. World cereal nitrogen use efficiency trends: review and current knowledge. Agrosystems, Geosciences & Environment, 2(1), pp. 1-8.
6. Woodward, T. R., Frame, W. H., Alley, M. M., Whitehurst, G. B. and Whitehurst, B. M., 2011. Design and validation of a laboratory system for measurement of volatilized ammonia. Agronomy Journal, 103(1), pp. 38-44.

What is claimed is:

1. A method of producing a porous carbon matrix product from a carbonaceous biomass material, comprising:
(a) treating the carbonaceous biomass material with at least one nitrogen-containing compound;
(b) applying a mineral acid to the carbonaceous biomass material while mixing both components for a period of time, thereby leaving the mineral acid impregnated in the carbonaceous biomass material and covalently binding the nitrogen-containing compound to the carbonaceous biomass material; and
(c) converting the mineral acid to its corresponding salt by exposing the acid-impregnated carbonaceous biomass material to ammonia,
wherein the porous carbon matrix product contains nitrogen covalently bound to the porous carbon matrix.

2. The method of claim 1, wherein step (b) is performed before step (a).

3. The method of claim 1, wherein the covalently bound nitrogen is from the nitrogen-containing compound and/or the salt.

4. The method of claim 1, wherein the carbonaceous biomass material comprises wood, digested, composted, or raw animal manure, lignocellulosic materials, agriculture wastes, agricultural by-products, organic residues, organic by-products, peat moss, bagasse, oil palm refuse, oil palm by-products, straw, municipal solid waste, bedding materials containing manure, food wastes and by-products, nut shells or coconut coir.

5. The method of claim 4, wherein the wood comprises wood shavings, wood pulp or wood powder.

6. The method of claim 1, wherein the at least one nitrogen-containing compound is present in an aqueous solution.

7. The method of claim 1, wherein the at least one nitrogen-containing compound comprises:
(a) an active or available carbonyl or imine group; and/or
(b) urea.

8. The method of claim 7, wherein the at least one nitrogen-containing compound comprises urea at an amount to achieve a specified nutrient profile.

9. The method of claim 1, wherein step (b) further comprises applying heat in addition to applying the mineral acid.

10. The method of claim 1, wherein the mineral acid is sulfuric acid, nitric acid, phosphoric acid, polyphosphoric acid, hydrochloric acid, and/or a combination thereof.

11. The method of claim 1, wherein the ammonia is ammonia gas or aqueous ammonia.

12. The method of claim 1, wherein step (c) comprises flowing an ammonia gas or aqueous ammonia over or through the acid-impregnated carbonaceous biomass material.

13. The method of claim 1, wherein the salt is ammonium sulfate, ammonium nitrate, ammonium phosphate or ammonium chloride.

14. The method of claim 1, further comprising:
(a) prior to the performance of steps (a), (b) and (c), grinding the carbonaceous biomass material to a suitable particle size range; and/or
(b) after step (c), screening, pelletizing or granulating the porous carbon matrix product to a suitable particle size range.

15. A porous carbon matrix product produced by the method of claim 1.

16. A slow-release fertilizer product comprising a porous carbon matrix and at least one nitrogen-containing compound covalently bound to the porous carbon matrix, wherein the porous carbon matrix is impregnated with a mineral acid salt of ammonia.

17. The slow-release fertilizer product of claim 16, wherein the at least one nitrogen-containing compound comprises:
(a) an active or available carbonyl or imine group; and/or
(b) urea.

18. The slow-release fertilizer product of claim 16, wherein the mineral acid is sulfuric acid, nitric acid, phosphoric acid, polyphosphoric acid, hydrochloric acid, and/or a combination thereof.

19. The slow-release fertilizer product of claim 16, wherein the at least one nitrogen-containing compound is released from the fertilizer due to microbial activity over the course of a growing season.

20. The porous carbon matrix product of claim 15, wherein the porous carbon matrix product reduces ammonia volatilization.
